(19) United States
(12) Patent Application Publication
(10) Pub. No.: US 2005/0196168 A1
(43) Pub. Date: Sep. 8, 2005

(54) Optical connection switching apparatus and management control unit thereof

(75) Inventors: Kouichirou Amemiya, Kawasaki (JP); Takao Naito, Kawasaki (JP); Toru Katagiri, Kawasaki (JP); Toshiki Tanaka, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/873,257

(22) Filed: Jun. 23, 2004

(30) Foreign Application Priority Data
Mar. 3, 2004 (JP) 2004-100796

(51) Int. Cl. H04J 14/00

(52) U.S. Cl. 398/45

(57) ABSTRACT

An optical connection switching according to the present invention comprises an optical connection switching fabric capable of making a connection between any one of optical input ports and any one of optical output ports, one or more optical transceiving units connected to a part of the optical input/output ports, and a management control unit for controlling the optical connection switching fabric to make a connection between the optical input/output port connected to the optical transceiving unit and the optical input/output port connected to the equipment for acquiring and managing information on the equipment by making a communication with the equipment through the use of the optical transceiving unit. This enables acquiring the information on the equipment having an optical communication interface to be optically connected, thereby automating the connection management of the equipment.

### BACKGROUND OF THE INVENTION

(1) Field of the Invention

The present invention relates to an optical connection (wiring) switching apparatus and a management control unit thereof, for example, an optical connection switching apparatus and a management control unit thereof suitable for the connection management in in-datacenter or in-company optical network or the like.

(2) Description of the Related Art

Along with the recent speeding-up of transmission signals and wide-spreading of networks, an optical signal network is being constructed which employs, as a transmission medium, an optical fiber having a large-bandwidth property and a low-loss property. Although the high-speed signal and the broadband transmission has been peculiar to the communications in the backbone networks so far, because of the appearance of various types of Ethernets (registered trademark), such as the Giga-bit Ethernet (GbE) and 10-Giga-bit Ethernet (10 GbE), and a fiber channel (FC), the speeding-up of transmission signals and the wide-spreading of the networks are advancing even in Ethernets such as LAN (Local Area Network) and other networks.

Along with this situation, the construction of an optical network is advancing even in a LAN using an Ethernet, a SAN (Storage Area Network) using a fiber channel and others. In such an optical network, various types of information apparatus (IT equipment) such as personal computers and a layer-2/layer-3 electric switch are connected to each other through the use of an optical fiber on a one-to-one basis, and at the construction or change of a network, there is a need to employ a facility capable of switching the optical signal path when a trouble (disorder) occurs.

For example, as the network in which these LAN and SAN exist in a state mixed, there is an in-datacenter network. In general, the optical connection in the datacenter is under management through the use of a connection control panel, in which optical adapters are arranged, called a patch panel and, for example, the optical path switching is realized by manually inserting/drawing fiber connectors, and the connection management is made through the tag attachment to both the ends of a fiber and the connection state recording made by the manual inputting.

Thus, as an enterprise network such as an in-datacenter network, a network has been constructed through the use of a Giga-bit Ethernet, 10-Giga-bit Ethernet, fiber channel (FC) or the like, and the transmission rate of this network has been as high as 1.0 Gbps, 10 Gbps or more and, as represented by a service such as a wide-area Ethernet, the transmission distance has been lengthened. For this reason, as the transmission medium, there has been employed an optical fiber superior in large-bandwidth property and low-loss property.

So far, the connection between IT (Information Technology) equipment and layer-2/layer-3 electric switch has been made on a one-to-one basis and, hence, there is a need to install a large number of optical fibers. Moreover, the connection management for these optical fibers has been made in the present situation. In general, the construction and change of a network system or the change of the connection of optical fibers stemming from the occurrence of a trouble lead to complicated operations such as optical fiber connection device confirmation tagging, connection diagram renewal and connection confirmation.

Such a network environment management method creates a problem in that there is a need to take a large number of processes. Moreover, in most cases, the actual wiring operations and the network construction operations are conducted in a separate fashion and there is a need to share the information on connection devices even in remote sites.

In addition, since the signals flowing an optical fiber range widely in type, such as various Ethernets (Ethernet, Fast Ethernet, Giga-bit Ethernet, 10-Giga-bit Ethernet) and fiber channels, mainframe interfaces (OCLINK, ESCON/FICON), for the connection of equipment having these interfaces (protocol and bit rate) through an electric switch, the number of electric switches (Ethernet switch, fiber channel switch, and others) is required to be equal to the number of types of interfaces, which leads to an extremely high cost.

For this reason, as the route switching apparatus handling high-speed signals in the Giga-bit Ethernet, the fiber channel or the like, a hopeful view is taken on an optical connection switching apparatus. This optical switch was originally developed for use in a transmission apparatus of a trunk network (backbone network) and, since the route switching can be made in a state of optical signal, the optical switch does not suffer from the delay occurring in an electric switch. Moreover, since there is no need to convert an optical signal into an electric signal, it also has a transparency in that it is possible to make the route switching on arbitrary protocols and arbitrary bit-rate signal.

In this connection, as a conventional technique on the fiber channel, there are techniques proposed, for example, in Japanese Patent Laid-open Nos. HEI 10-135952 and HEI 11-65980. The technique of Japanese Patent Laid-open No. HEI 10-135952 is for providing a fiber channel exchange which mutually connects a plurality of equipment to each other through node ports (N ports) related thereto, and the technique of Japanese Patent Laid-open No. HEI 11-65980 is for, in the connection configuration using fabrics in a fiber channel interface, speeding up the response of the fabrics.

In addition, as the conventional network interface apparatus, there are the techniques proposed in Japanese Patent Laid-Open Nos. 2000-341359 and 2000-209622. The technique of Japanese Patent Laid-Open No. 2000-341359 is for providing an apparatus capable of making the re-construction of ports in a communication network efficiently at a low cost, and includes a plurality of optical ports and a plurality of electronic circuits and an electronic switch disposed between the plurality of optical ports and the plurality of electronic circuits to re-construct the connection between one selected from the plurality of optical ports and one of the electronic circuits. The technique of Japanese Patent Laid-Open No. 2000-209622 relates to a serial transmission switching system capable of coping flexibly with the addition or change of the existing transmission-rate communication equipment and the addition of new transmission-rate communication equipment.

Still additionally, as the conventional techniques related to the fiber channel and the Giga-bit Ethernet, there is a technique proposed in Japanese Patent Laid-Open No. 2002-232409. This technique relates to a pattern detecting method and apparatus for monitoring a data stream in the fiber channel, Giga-bit Ethernet and others. That is, to most interfaces, as in the case of the fast fiber channel and Giga-bit Ethernet interface, it is useful to produce a special data stream with attention being paid to a given jitter in the interface and/or the equipment or other similar deterioration characteristics. Therefore, such a test apparatus is operated at a specified time of the data stream.

For the management of the optical connections (wiring) in a optical network such as an optical LAN (Local Area Network) constructed using an optical connection switching apparatus (optical switch) in a datacenter or in an enterprise, there is a need to capture what type (for example, protocol or bit rate) of equipment is connected to each port of the optical connection switching apparatus (information about the equipment). Although this requires monitoring the contents of an optical signal, it is impossible, for that the existing optical connection switching apparatus is not designed to analyze the contents of an optical signal while conducting the route switching in a state of the optical signal. This also applies to the aforesaid Japanese Patent Laid-Open Nos. HEI 10-135952, 2000-341359, HEI 11-65980, 2000-209622 and 2002-232409, and these documents does not disclose nor teach a technique of capturing which of ports of an optical switch is connected to what type of equipment for the connection management.

### SUMMARY OF THE INVENTION

The present invention has been developed with a view to eliminating the above-mentioned problems, and it is therefore an object of the invention to provide an optical connection switching apparatus and a management control unit therefor capable of acquiring the information on equipment having an optical communication interface to be optically connected, for carrying out the automatic connection management on this equipment.

For this purpose, in accordance with an aspect of the present invention, there is provided an optical connection switching apparatus to which a plurality of equipment each having an optical communication interface are connected and which is made to establish an optical connection therebetween, the apparatus comprising an optical connection switching fabric having a plurality of an optical input/output ports each of which includes a pair of optical input port and an optical output port and is capable of making a connection between any one of the optical input ports and any one of the optical output ports, one or more optical transceiving units connected to a part of the optical input/output ports, and a management control unit for controlling the optical connection switching fabric to make a connection between the optical input/output port connected to the optical transceiving unit and the optical input/output port connected to the equipment for acquiring and managing information on the equipment by making a communication with the equipment through the use of the optical transceiving unit.

In this case, it is also appropriate that the management control unit includes an equipment information storing unit for storing one of a physical address and a logical address of the equipment, or both the addresses, as the information (which will be referred to hereinafter as “equipment information”) on the equipment acquired by the communication with the equipment in a state associated with information on the optical input/output port.

In addition, it is also appropriate that the management control unit includes an equipment state monitoring unit for monitoring connection, a disconnection or a communication state of the equipment by monitoring optical power information on the optical input/output port.

Still additionally, it is also appropriate that, in the optical connection switching apparatus, a light-receiving element is provided with respect to the optical input port of the optical connection switching fabric, and the equipment state monitoring unit is constructed as an input port equipment state monitoring unit which handles, as the optical power information, a quantity of light reception by the light-receiving element to monitor the connection, disconnection or communication state of the equipment by monitoring a variation of the optical power information.

Furthermore, in accordance with a further aspect of the present invention, there is provided a management control unit for an optical connection switching apparatus which includes an optical connection switching fabric having a plurality of an optical input/output ports each of which is composed of a pair of optical input port and an optical output port and which is capable of making a connection between any one of the optical input ports and any one of the optical output ports, with each of a plurality of equipment each having an optical communication interface being connected to any one of the optical input/output ports to establish an optical connection between the equipment, the management control unit comprising one or more optical transceiving units connected to a part of the optical input/output ports and a management control unit for controlling the optical connection switching fabric to make a connection between the optical input/output port connected to the optical transceiving unit and the optical input/output port connected to the equipment for acquiring and managing information on the equipment by making a communication with the equipment through the use of the optical transceiving unit.

According to the present invention, the optical connection switching fabric is controlled to make the connection between the optical input/output port connected to the optical transceiving unit and the optical input/output port connected to the equipment so that the communication is made with the connected equipment through the use of the optical transceiving unit to acquire and manage the information on the equipment, thus automating the connection management on the connected equipment to considerably shortening the time needed for this operation, which can considerably reduce the operation management cost as a result.

Moreover, the connection, disconnection or communication state of the equipment can be monitored by monitoring the optical power information on the optical input/output port of the optical connection switching fabric, which can achieve the automation of the inter-port connection switching and which can also automate the connection switching at the re-construction of a network using this optical connection switching apparatus or at the occurrence of a trouble. This can considerably reduce the time needed for this operation and can cut the operation management cost of the network.

### BRIEF DESCRIPTION OF THE DRAWINGS

FIG. 1 is a block diagram showing a configuration of an optical connection automatic-switching apparatus (optical connection switching apparatus) according to an embodiment of the present invention;

FIG. 2 is a block diagram useful for explaining an IT equipment connection and disconnection automatic-recognition function (in a case in which an optical input port is equipped with a light-receiving element) of the optical connection automatic-switching apparatus shown in FIG. 1;

FIG. 3 is a block diagram useful for explaining an IT equipment connection and disconnection automatic-recognition function (in a case in which an optical output port is equipped with a light-receiving element) of the optical connection automatic-switching apparatus shown in FIG. 1;

FIG. 4 is a block diagram showing an example of the allocation of a monitor charge port in a case in which a plurality of optical power monitoring ports are provided in the optical connection automatic-switching apparatus shown in FIG. 1;

FIG. 5 is a flow chart useful for explaining an operation (control) at equipment connection by the optical connection automatic-switching apparatus (management control circuit) shown in FIG. 1;

FIG. 6 is a block diagram useful for explaining a redundant path switching function of the optical connection automatic-switching apparatus shown in FIG. 1;

FIG. 7 is a block diagram showing a modification of a redundant path switching function of the optical connection automatic-switching apparatus shown in FIG. 1;

FIG. 8 is a block diagram useful for explaining an IT equipment connection recognition function according to an input/output port direct-coupling method of the optical connection automatic-switching apparatus shown in FIG. 1;

FIG. 9 is a block diagram showing a connection example in an optical connection switching fabric for explaining an IT equipment connection recognition function according to an adjacent input/output port direct-coupling method (quasi-fixing method) of the optical connection automatic-switching apparatus shown in FIG. 1;

FIG. 10(A) is a block diagram showing a connection example in an optical connection switching fabric for explaining an IT equipment connection recognition function according to an adjacent input/output port direct-coupling method (quasi-fixing method) of the optical connection automatic-switching apparatus shown in FIG. 1;

FIG. 10(B) is an illustration of a registration example of an equipment information table in the connection example shown in FIG. 10(A);

FIG. 11(A) is a block diagram showing a connection example in an optical connection switching fabric for explaining an IT equipment connection recognition function according to an adjacent input/output port direct-coupling method (quasi-fixing method) of the optical connection automatic-switching apparatus shown in FIG. 1;

FIG. 11(B) is an illustration of a registration example of an equipment information table in the connection example shown in FIG. 11(A);

FIG. 12(A) is a block diagram showing a connection example in an optical connection switching fabric for explaining an IT equipment connection recognition function according to an adjacent input/output port direct-coupling method (quasi-fixing method) of the optical connection automatic-switching apparatus shown in FIG. 1;

FIG. 12(B) is an illustration of a variation of the registration contents in an optical power information table in the connection example shown in FIG. 12(A);

FIG. 12(C) is an illustration of a variation of the registration contents in an equipment information table in the connection example shown in FIG. 12(A);

FIG. 13 is a block diagram useful for explaining an IT equipment connection recognition function based on the association between equipment information and optical power information in the optical connection automatic-switching apparatus shown in FIG. 1;

FIG. 14 is a block diagram useful for explaining an IT equipment connection recognition function based on the association between equipment information and optical power information in the optical connection automatic-switching apparatus shown in FIG. 1;

FIG. 15 is a block diagram useful for explaining an IT equipment connection recognition function based on the association between equipment information and optical power information in the optical connection automatic-switching apparatus shown in FIG. 1; and

FIG. 16 is a block diagram useful for explaining a redundant path switching function in a case in which a disconnection of an optical output port side optical link in the configuration shown in FIG. 6 or 7.

### DESCRIPTION OF THE PREFERRED EMBODIMENTS

[A] Description of Embodiment

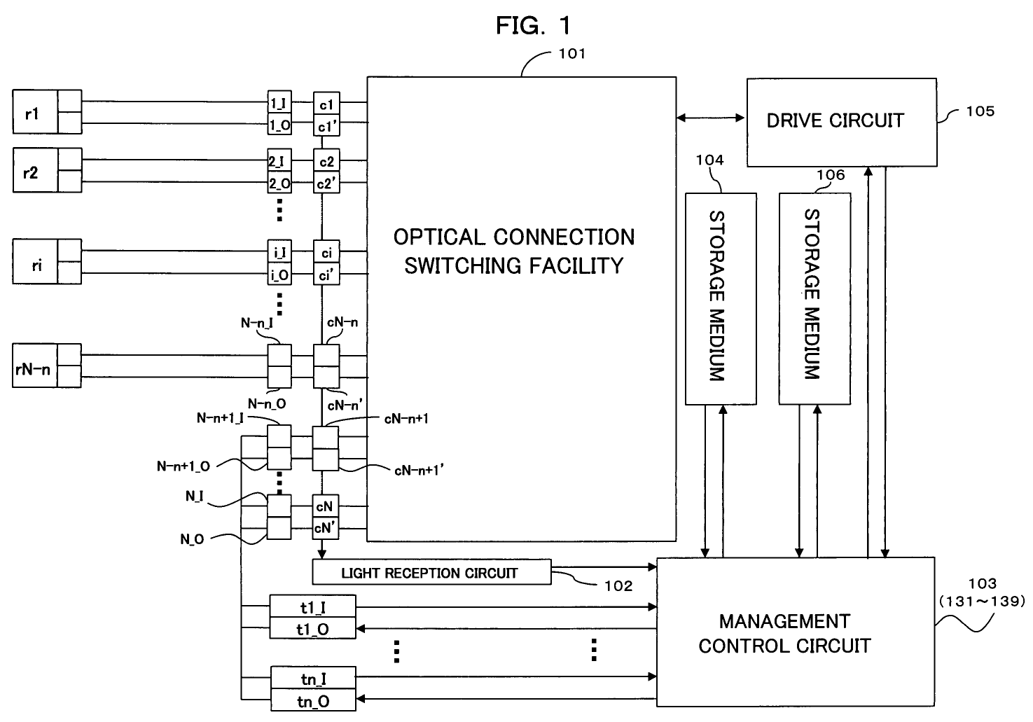

FIG. 1 is a block diagram showing a configuration of an optical connection automatic-switching apparatus according to an embodiment of the present invention. In FIG. 1, the optical connection automatic-switching apparatus is made up of optical input ports 1_I, 2_I, . . . , N-n_I and optical output ports 1_O, 2_O . . . , N-n_O serving as a plurality (N-n) of sets of IT equipment connection ports which come into connection with a plurality of IT equipment (information equipment) r1, r2, . . . , rN-n (N≧2, 1≦n<N) each having a desired optical communication interface (communication protocol and bit rate, optical input ports N-n+1_I, . . . , N_1 and optical output ports N-n+1_O, . . . , N_O serving as n sets of control ports corresponding to the number of types of handled interfaces of the IT equipment r1, r2, . . . , rN-n, an optical connection switching fabric (optical switch) 101 connected through optical wiring (optical fibers) to then sets of ports 1_I, 2_I, . . . , N_1 and 1_O, 2_O, . . . , N_O in total, alight reception circuit 102, a management control circuit 103, storage media 104, 106, a drive circuit 105, and a plurality (n) of sets of optical transmitters t1_O, t2_O, . . . , tn_O and optical receivers t1_I, t2_I, . . . , tn_1 (which sometimes will collectively be referred to hereinafter as optical transceiving units t1, t2, . . . , tn).

In addition, in this optical connection automatic-switching apparatus, each of the N (sets) ports in total is equipped with an optical branch circuit for taking a portion of input light and/or output light and a light-receiving element such as a PIN photodiode for measuring the optical intensity. In this configuration, there are a case in which the respective optical output ports (transmission ports) 1_O, 2_O, . . . , N_O are equipped with these optical branch circuits and light-receiving elements as indicated by marks c1′, c2′, . . . , cN′ in FIG. 1, a case in which the respective optical input ports (reception ports) 1_I, 2_I, . . . , N_I are equipped with these optical branch circuits and light-receiving elements as indicated by marks c1, c2, . . . , cN in FIG. 1, and a case in which both the optical input ports 1_I, 2_I, . . . , N_I and optical output ports 1_O, 2_O, . . . , N_O are equipped therewith. In the following description, when the paired optical input ports i_I (i=1 to N) and optical output ports i_O are discriminated from each other, they will be referred to collectively as optical input/output ports i_IO.

Still additionally, the n optical input ports (control ports) N-n+I_I, . . . , N_I are connected to the n optical transmitters t1_O, t2_O, . . . , tn_O on a one-to-one basis, and the n optical receivers t1_I, t2_I, . . . , tn_I are respectively connected to the n optical output ports (control ports) N-n+1_O, . . . , N_O, paired with the aforesaid optical input ports j_I (j=N-n to N), in one-to-one relation to each other, and in accordance with the inter-port connection switching in the optical connection switching fabric, the communication can be made between any one of the IT equipment (which sometimes will hereinafter be referred to simply as “equipment”) r1, r2, . . . , rN-n and the management control circuit 103 through these control ports j_I and j_O.

Incidentally, in this embodiment, the control ports and optical transceiving units are n (≧1) in number, which corresponds to the number of types of handled optical communication interfaces (which sometimes will hereinafter be referred to simply as “interfaces”) of the IT equipment r1, r2, . . . , rN-n, and which depends upon the numbers of the handled protocols and bit rates of the IT equipment r1, r2, . . . , rN-n. However, if multi-interface handling optical transceiving units t1, t2, . . . , tn can be prepared which have a plurality of types of communication functions corresponding to a plurality of types of interfaces (multi-interface, multi-bit-rate) which can be provided in the IT equipment r1, r2, . . . , rN-n, it is possible to decrease the number of control ports and number n of optical transceiving units up to n=1 which is at a minimum, thus realizing the cost reduction of this optical connection automatic-switching apparatus.

In this configuration, the optical connection switching fabric (optical switch) 101 is driven by the drive circuit 105 to switch the connection (optical link) between any ports 1_I, 2_I, . . . , N_I and 1_O, 2_O, . . . , N-O, thereby enabling the communication between any IT equipment r1, r2, . . . , rN-n (if discriminated from each other, they will hereinafter be referred to as “IT equipment r”) connected to this optical connection automatic-switching apparatus.

The light reception circuit 102, the management control circuit 103, the storage media 104, 106 and the drive circuit 105 constitute a management control unit which controls the optical connection switching fabric 101 to make a connection between the control port (optical input/output port) j_IO connected to the optical transceiving unit tk (k=1 to n) and the IT equipment connection port i-IO connected to the IT equipment r so that a communication with the IT equipment r is made through the use of this optical transceiving unit tk to acquire and manage information (equipment information such as address information) on the equipment r.

That is, the light reception circuit 102 receives the optical power information obtained by the light-receiving elements c1, c2, . . . , cN or c1′, c2′, . . . , cN′ and transmits it to the management control circuit 103, while the management control circuit (management control unit) 103 has a function to analyze a data frame obtained by making communication with an arbitrary IT equipment connected to the optical connection switching fabric 101 through the use of any one of the optical transceiving units tk, a function (network automatic-construction function) to control the drive circuit 105 for controlling the inter-port connection switching in the optical connection switching fabric 101, a function of storage control on the storage media 104 and 106, an IT equipment connection/disconnection automatic-recognition function, an IT equipment interface automatic-recognition function, an inter-IT-equipment communication monitor function, a redundant path switching function, and others.

In this connection, when this management control circuit 103 itself, or together with the storage media 104, 106 and the drive circuit 105, is mounted as one function such as maintenance terminal remote from the optical connection switching fabric 101, the remote control can also be made with respect to the optical connection switching fabric 101. Moreover, each of the aforesaid optical transmitters t1_O, t2_O, . . . , tn_O has an electrical/optical (E/O) conversion function while each of the optical receivers t1_I, t2_I, . . . , tn_I has an optical/electrical (O/E) conversion function, and the communication is made between the management control circuit 103 and these optical transceiving units tk through electric signals.

The storage medium (equipment information storage unit) 104 is for storing the information (equipment information) about the IT equipment r connected to each of the ports 1_I, 2_I, . . . , N-n_I and 1_O, 2_O, . . . , N-n_O and, for example, retains one of or both a physical address and logical address of the IT equipment r (attainable through the aforesaid data frame analysis) and an IT equipment connection port number in a state associated with each other for specifying the IT equipment r (for example, see after-shown table 2). Another storage medium (optical power information, storage unit) 106 is for retaining transmission optical power information (obtained through the light-receiving elements c1, c2, . . . , cN or c1′, c2′, . . . , cN′ and the light reception circuit 102) from the IT equipment r in a state associated with the IT equipment connection port number.

Incidentally, as each of these storage media 104 and 106, a random access memory (RAM), a magnetic disk, an optical disk, a magneto optical disk or the like is employable. Moreover, these storage media 104 and 106 can also be realized by dividing a storage area of a single storage medium according to information to be stored.

With the above-described configuration, the user of this optical connection automatic-switching apparatus can realize the correct connections and communications without being aware of the optical communication interface (protocol and bit rate) used in that IT equipment r only by making a connection of the IT equipment r with any IT equipment connection port 1_I, 2_I, . . . , N-n_I and 1_O, 2_O, . . . , N-n_O. A more detailed description will be given hereinbelow.

(a) IT Equipment Connection and Disconnection Recognition Function

With the above-described configuration, the management control circuit 103 can automatically recognize the fact that IT equipment r is newly connected to the optical connection automatic-switching apparatus.

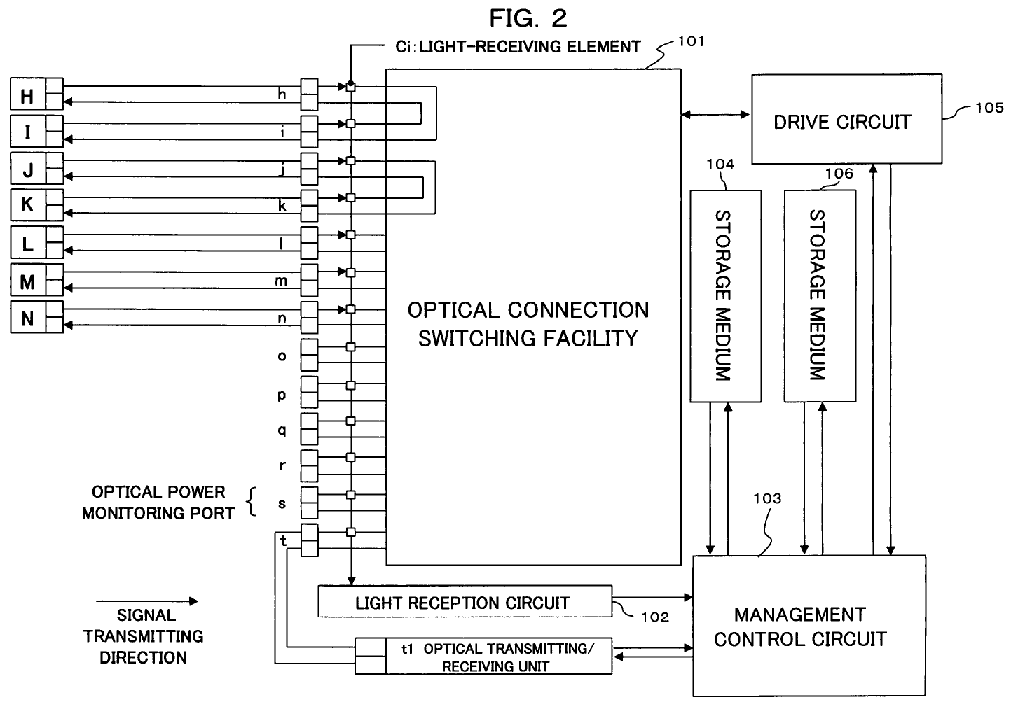

(a-1) Case in which a light-receiving element is provided in an optical input port of the optical connection automatic-switching apparatus (see FIG. 2).

In a case in which the light-receiving elements c1, c2, . . . , cN are provided in the optical input ports 1_I, 2_I, . . . , N_I of the optical connection automatic-switching apparatus as described above with reference to FIG. 1, the management control circuit 103 is set to monitor the optical power information, obtained from the light-receiving elements c1, c2, . . . , cN through the light reception circuit 102, at all times. In FIG. 2, for convenience only, without making a discrimination between the optical input ports and the optical output ports, the number of all the ports (optical input/output ports) are set at 13 (ports h to t) as port number=h to t, and the IT equipment H to N are connectable to the ports h to n, respectively.

For example, in a case in which the IT equipment J having an optical communication interface [optical/electrical (O/E) conversion function] is connected to the IT equipment connection port j, light is incident from this IT equipment J on the port j and is received by the light-receiving element cj provided in the port j and transmitted through the light reception circuit 102 to the management control circuit 103.

Accordingly, the management control circuit 103 can recognize a variation of the light reception quantity (an increase in light reception quantity) about the port j, and it can automatically recognize the fact that the IT equipment J having the optical communication interface is connected to the port j.

Incidentally, although in FIGS. 1 and 2 all the optical input ports 1_I, 2_I, . . . , N_I are respectively equipped with the light-receiving elements c1, c2, . . . , cN, when the optical input ports (IT equipment connection ports) 1_I, 2_I, . . . , N-n_I to which at least the IT equipment r is connectable are equipped therewith, the connection/disconnection automatic-recognition of the IT equipment r becomes feasible.

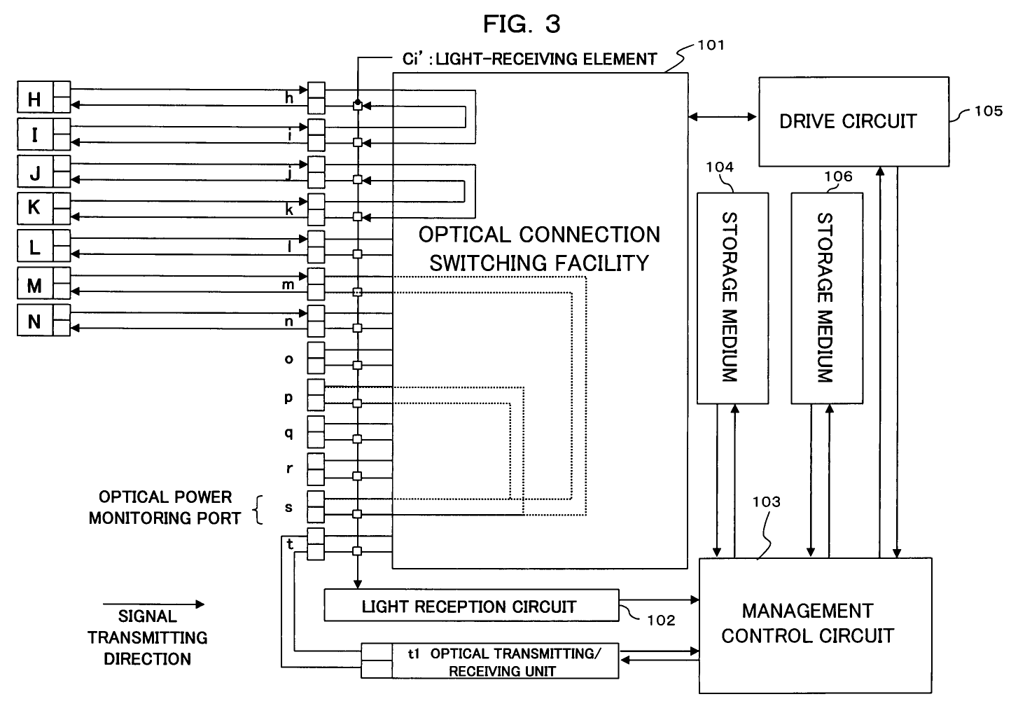

(a-2) Case in which a light-receiving element is provided in an optical output port of the optical connection automatic-switching apparatus (see FIG. 3).

In a case in which the respective optical output ports 1_O, 2_O, . . . , N_O of the optical connection automatic-switching apparatus are equipped with the light-receiving elements c1′, c2′, . . . , cN′ (when the light-receiving elements c1, c2, . . . , cN are not provided in the optical input ports 1_I, 2_I, . . . , N_I), even if the IT equipment r is connected to this optical connection automatic-switching apparatus, the connection is not recognizable in this state. Therefore, in this case, the port of port number=s is used as the control port (optical power monitoring port), and the management control circuit 103 controls the optical connection switching fabric 101 through the use of the drive circuit 105 to successively (in a circulative manner) make connections of a plurality of IT equipment connection ports h to r with the optical power monitoring port s (no order required) so that the optical power monitor information obtained by the light-receiving element cs′ provided in the optical output port of the optical power monitoring port s is transmitted to the management control circuit 103.

Thus, the management control circuit 103 can monitor the optical power information on the respective IT equipment connection ports h to r at all times and, in a case in which the IT equipment r having the optical communication interface is connected to any equipment connection port h to r, the optical power information is transferred to the management control circuit 103, thereby enabling the automatic recognition on the new connection of the IT equipment r. Therefore, in the case of this embodiment, if at least the control port (optical power monitoring port) s is equipped with the light-receiving element cs′, the connection/disconnection automatic-recognition on the IT equipment becomes feasible.

That is, the functions of the aforesaid (a-1) and (a-2) signify that the management control circuit 103 has a function as an equipment state monitoring unit 131 (see FIG. 1) to monitor the connection, disconnection or communication state of the IT equipment r by monitoring the optical power information on the optical input/output port i_IO of the optical connection switching fabric 101 and this equipment state monitoring unit 131 has the following functions (1) and (2) according to the light-receiving element location (port), with the function (2) including the following function (3). That is:
(1) a function as an input port equipment state monitoring unit 132 (see FIG. 1) to, in a case in which the optical input port i_I is equipped with the light-receiving element ci, monitor the connection, disconnection or communication state of the IT equipment r by monitoring a variation of the light reception quantity in the light-receiving element ci with the light reception quantity being handled as the optical power information;
(2) a function as an output port equipment state monitoring unit 133 to, in a case in which the optical output port i_O is equipped with the light-receiving element ci′, control the optical connection switching fabric 101 for making a connection between the optical input port which is connected to the IT equipment r and the optical output port (optical power monitoring port) s which is not connected to the IT equipment so that a variation of the light reception quantity in the light-receiving element cs′ of this port s is monitored with the light reception quantity being handled as the optical power information, thereby monitoring the connection, disconnection or communication state of the IT equipment r; and
(3) a function as a port circulation (cyclic) connection control unit 134 to control the optical connection switching fabric 101 for making the circulative connections between a plurality of optical input ports i_I connected to the IT equipment r and the optical output port j_O serving as the optical power monitoring port which is not connected to the IT equipment r.

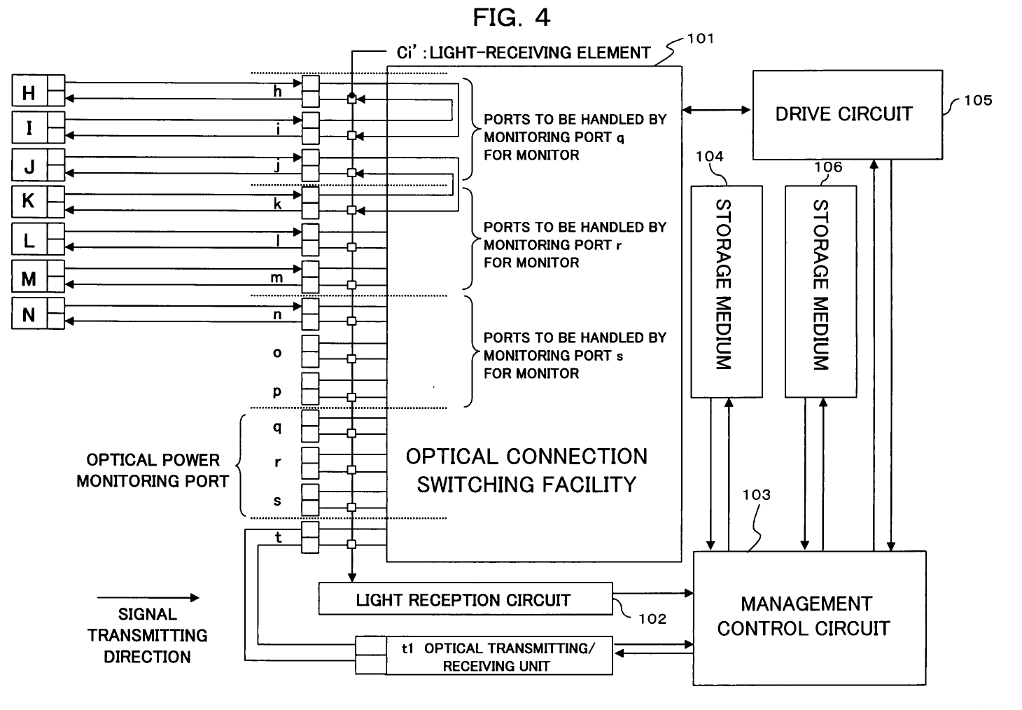

Meanwhile, in the case of the employment of the aforesaid methods, since the IT equipment connection ports h to r are monitored in succession (in a circulating fashion), the time lag (delay) occurs in terms of the equipment connection recognition. Accordingly, for example, it is considered to employ a method in which not only the number of optical power monitoring ports is increased but also the number of equipment connection ports to be monitored through the optical power monitoring ports is decreased and even the circulation period is shortened. That is, for example, as shown in FIG. 4, each of the ports q, r and s is used as the optical power monitoring port so that these ports q, r and s share the IT equipment connection ports i_IO which are an object of monitor (in FIG. 4, the port q monitors the optical power information on the ports h, i, j, the port r monitors the optical power information on the ports k, l, m, and the port s monitors the optical power information on the ports n, o, p).

This can reduce the number of equipment connection ports one optical power monitoring port takes charge of and shorten the circulation monitor period, which can achieve the fast monitor more efficiently. Incidentally, the maximum number of optical power monitoring ports to be used becomes equal to the number of equipment connection ports.

Moreover, in the case of both the above-mentioned (a-1) and (a-2), a decision as to whether the IT equipment r is connected or not is made according to the following method. That is, a given threshold is set with respect to the optical power monitor value and, when the optical power monitor value varies to exceed the threshold, a decision is made that the connection of the equipment r newly takes place. On the other hand, if the optical power monitor value varies to become a value below the threshold, a decision is made that the equipment r is connected or some trouble occurs.

(b) In-Datacenter IT Equipment Automatic-Recognition by the Optical Connection Automatic-Switching Apparatus (Single Interface).

In a case in which the equipment r is newly connected to any one of the ports i_IO of this optical connection automatic-switching apparatus, as mentioned above, owing to the light-receiving element c1, c2, . . . , cN provided in the optical input port 1_I, 2_I, . . . , N_1 of the optical connection automatic-switching apparatus or the light-receiving element c1′, c2′, . . . , cN′ provided in the optical output port 1_O, 2_O, . . . , N_O thereof, the information indicative of the new connection of the equipment r is sent to the management control circuit 103. The management control circuit 103 controls the optical connection switching fabric 101 through the use of the drive circuit 105 to make a connection of the optical input/output port i_IO connected to the equipment r with any optical input/output port (control port) j_IO connected to the optical transceiving unit tk connected to the management control circuit 103.

Moreover, the management control circuit 103 transmits a response request through the optical transceiving unit tk to the connected equipment r. Upon receipt of the response request, the equipment r transmits a data frame including the information on an address (logical or physical address) allocated to this equipment r to the transmission side address, and the management control circuit 103 receives the data frame through the optical transceiving unit tk in the form of an electric signal and acquires the transmission side address information stored in the data frame. Thus, the management control circuit 103 can make out a port-address correspondence table in which the acquired address information and the port (number) of the optical connection automatic-switching apparatus are associated with each other. This correspondence table is retained and managed in the storage medium 104.

(c) Datacenter IT Equipment Automatic-Recognition by the Optical Connection Automatic-Switching Apparatus (Multi-Interface)

In a case in which the equipment r is newly connected to any one of the ports i_Io of this optical connection automatic-switching apparatus, also in this case, owing to the light-receiving element c1, c2, . . . , cN provided in the optical input port 1_I, 2_I, . . . , N_1 of the optical connection automatic-switching apparatus or the light-receiving element c1′, c2′, . . . , cN′ provided in the optical output port 1_O 2_O . . . , N_O thereof, the information indicative of the connection of the equipment r is sent to the management control circuit 103. Upon receipt of this information, the management control circuit 103 carries out an interface decision process on the connected equipment r.

That is, as the optical transceiving unit tk to be connected to the management control circuit 103 of this optical connection automatic-switching apparatus, there is prepared the Ethernet, fiber channel or other data frame readable means. The management control circuit 103 performs the protocol and bit rate scanning on the equipment r connected to the equipment newly connected through the optical transceiving unit tk to obtain the type of the interface of this equipment r and the physical address and/or the logical address of the equipment r and further to preserve these information, for example, in the storage medium 104 or 106.

The following table 1 shows an example of the scanning items. Although this example includes the Ethernet and fiber channel, naturally, it is possible to handle the equipment r1, r2, . . . , rN-n using other protocols as communication means by employing the optical transceiving unit tk capable of reading the other protocols.

TABLE 1
Example of Bit Rate/Protocol Scanning Items

| | 100 | 200 | 400 | 1 | 2 | 4 | 10 |
|---|---|---|---|---|---|---|---|
| | Mbps | Mbps | Mbps | Gbps | Gbps | Gbps | Gbps |
| Ethernet | OK | — | — | OK | — | — | OK |
| FC*1 | OK | OK | OK | OK | OK | OK | — |
| Others | *2 | *2 | *2 | *2 | *2 | *2 | *2 |

In this table 1,
*1 represent FC: Fiber Channel, and
*2 signifies depending on protocol to be used.

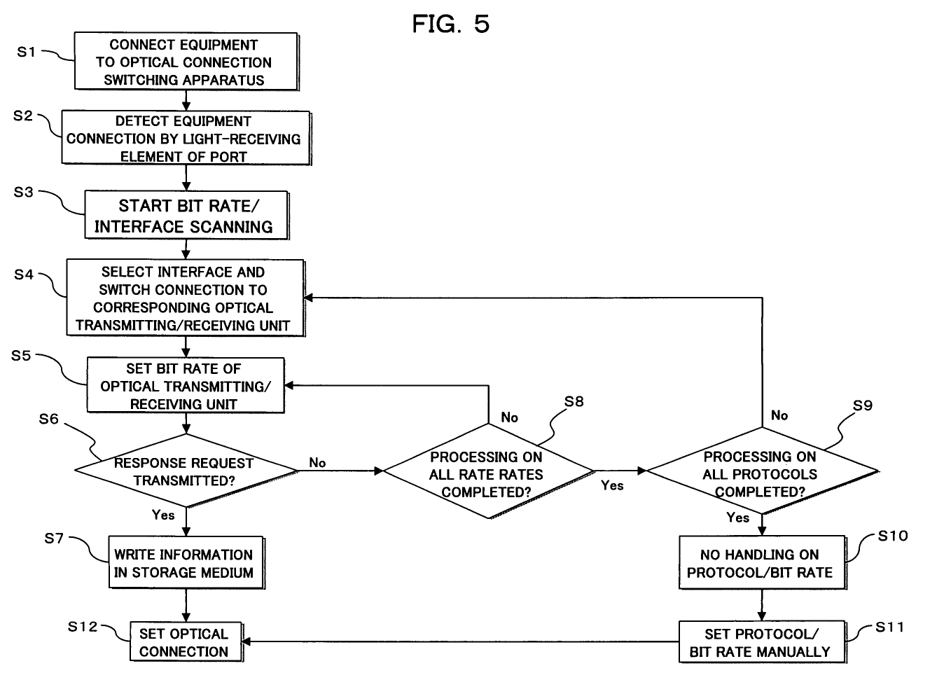

Secondly, referring to a flow chart of FIG. 5, a description will be given hereinbelow of a detailed procedure to be conducted from when the equipment r is connected to this optical connection automatic-switching apparatus until the communication is realized between the equipment r. In the following description, Although, as the order of the interface scanning, the protocol scanning is first conducted and the bit rate scanning is then done, the reverse order is also acceptable.

First of all, when the equipment r having an optical connection port is newly connected to any port i_IO of the optical connection automatic-switching apparatus (step S1), according to any one of the methods mentioned above in the item (a), the management control circuit 103 detects that the equipment r is connected to the port i_IO (step S2). Concretely, as mentioned above, a given threshold is set in conjunction with the light reception level and, when the light reception level exceeds this threshold, a decision is made as the connection of the equipment r.

Following this, the management control circuit (which will hereinafter be referred to simply as a “control circuit”) 103 controls the optical connection switching fabric 101 to make a connection between the port i_IO connected to the equipment r and the port j_IO connected to the optical transceiving unit tk corresponding to the protocol to be scanned (steps S3 and S4). In this connection, if an optical transceiving unit tk is employed which handles the multi-interface (protocol), instead of this port switching by the optical connection switching fabric 101, the selection/setting of the communication function (protocol) of the optical transceiving unit tk by the management control circuit 103 alone will avail.

Subsequently, for example, according to the aforesaid table 1, the control circuit 103 sets a bit rate of the optical transceiving unit tk (step S5), and transmits a response request through this optical transceiving unit tk to the connected equipment r. If there is a response (reception of a data frame) from that equipment r, the control circuit 103 analyzes the contents of the data frame and the specification of the equipment r reaches completion. Accordingly, the control circuit 103 stores, for example, in the storage medium 104, the information peculiar to the equipment r such as the information on one of or both the physical address and logical address of the equipment r (through Yes route of step S6 to step S7).

On the other hand, in the case of no response to the aforesaid response request, the control circuit 103 confirms whether or not the processing on all the bit rates which are an object of scanning reaches completion (through No route of step S6 to step S8). If it does not reach completion yet, the control circuit 103 changes the bit rate setting of the optical transceiving unit tk (through No route of step S8 to step S5). At this time, if the optical transceiving unit tk can handle the multi-bit-rate, also in this case, instead of the port switching by the optical connection switching fabric 101, the bit rate setting on the optical transceiving unit tk by the management control circuit 103 will avail. If the optical transceiving unit tk cannot handle the multi-bit-rate, the optical transceiving unit tk is provided for each bit rate and the control circuit 103 controls the optical connection switching fabric 101 to make a connection between the port j_IO connected to that optical transceiving unit tk and the port i_IO connected to the equipment r which is an object of scanning at present.

In a case in which there is no response when the scanning on all the bit rates takes place (No in step S6 and Yes in step S8), for changing the interface, the control circuit 103 controls the optical connection switching fabric 101 to make a connection between the port i_IO connected to the equipment r and the port k_IO connected to another optical transceiving unit tk (k=1 to n, k≠i) (through No route of step S9 to step S4). Also in this case, if the multi-protocol handling optical transceiving unit tk is provided, instead of the port switching by the optical connection switching fabric 101, the setting by the control circuit 103 alone will avail.

Thereafter, the control circuit 103 repeatedly carries out the processing in the aforesaid steps S4, S5 and S6 (i.e., bit rate scanning and protocol scanning) until the corresponding interface is found by the reception of a response from the connected equipment r. If the corresponding interface is found, at this time, the information peculiar to this equipment r is stored, for example, in the storage medium 104 (step S7).

In a case in which, although the protocol scanning on all the protocols reaches completion, the corresponding interface is not found yet (Yes in step S9), the control circuit 103 makes a decision that it is impossible to handle the interface of this equipment r (step S10). In this case, a maintenance person or the like manually sets the peculiar information such as address information on this equipment r (step S11).

That is, in this case, the control circuit 103 has a function as an interface scanning unit 135 (see FIG. 1) to control the optical connection switching fabric 101 for making circulating connections of the optical input/output ports j_IO connected to a plurality of optical transceiving units tk with the optical input/output port i_IO connected to the IT equipment r (no order necessary) so that the information on the IT equipment r is acquired through the use of the optical transceiving units tk, or to perform the circulating selection/setting of the communication function (protocol, bit rate and others) of the multi-interface handling optical transceiving unit tk so that the information on the IT equipment r is acquired through the use of the optical transceiving unit tk.

Moreover, the above-mentioned interface scanning processing is conducted with respect to all the newly connected equipment r, so a table in which the respective ports i_IO and the connected equipment r are associated with each other is produced in the storage medium 104. Still moreover, the control circuit 103 controls the optical connection switching fabric 101 on the basis of the contents of this table to make the mutual connections among the equipment r (optical connection setting) (step S12). Thus, the connections among the equipment r come to an end. That is, the control circuit 103 functions as a inter-port connection control unit 136 to implement the inter-port connection control in the optical connection switching fabric 101 on the basis of the equipment information in the storage medium 104.

Through the use of the above-described methods, the user of this optical connection automatic-switching apparatus can realize the correct inter-equipment connections only by making the connection to any port i_IO of this optical connection automatic-switching apparatus without paying attention to the type (protocol) of the optical communication interface of the equipment r to be connected, the bit rate and others.

(d) In-datacenter Network Monitoring Function

Since the information flowing on an in-datacenter network is mission critical, the network monitoring function is significantly important. A description will be given hereinbelow of a network monitoring function using this optical connection automatic-switching apparatus.

For example, in FIG. 2 or 3, let it be assumed that, in a normal operation in which a work application is in action on a network, the IT equipment H, I, J and K in which applications are in action are connected to the ports h, i, j and k of the optical connection automatic-switching apparatus and the connection is made through the optical connection automatic-switching apparatus between the ports h-i and between the ports j-k. Moreover, to the different ports l, m and n, there are connected the IT equipment L, M and N each of which is in stand-by condition, while the other ports o, p, q and r are in a free condition. In this state, there is a need to implement the network monitor through the use of the ports h, i, j and k without affecting the applications which are in action. The procedure therefor is as follows.

(d-1) Case in which a light-receiving element is provided in an optical input port of an IT equipment connection port in the optical connection automatic-switching apparatus.

When each light-receiving element ci is provided in each IT equipment connection port (optical input port) i_I of the optical connection automatic-switching apparatus as mentioned above with reference to FIG. 1, the optical power monitor can be made through the use of this light-receiving element ci without exerting influence on the application which is in operation (while continuing the operation). The monitor information is transmitted through the light reception circuit 102 to the control circuit 103 and is retained as the optical power monitor information, for example, in the storage medium 106.

(d-2) Case in which no light-receiving element is provided in an optical input port of the IT equipment connection port of the optical connection automatic-switching apparatus

In a case in which, as mentioned above with reference to FIG. 1, the light-receiving element ci′ is provided in the IT equipment connection port (optical output port i_O) of the optical connection automatic-switching apparatus while no light-receiving element is provided in the paired IT equipment connection port (optical input port), also in this embodiment, for example, the port s is used as an optical power monitoring port for monitoring the optical power. This optical power monitoring port s and the other control port can be put in common use. Moreover, the number of optical power monitoring ports are increasable as far as the number of ports of the optical connection automatic-switching apparatus permits. However, the increase in number of optical power monitoring ports enhances the monitoring efficiency as mentioned above with reference to FIG. 4 but decreasing the number of ports connectable to the IT equipment r, which leads to the trade-off.

First, a description will be given hereinbelow of a procedure in the case of monitoring the ports o, p, q, r to which the IT equipment r is not connected and the ports l, m, n which are not in connection with the IT equipment r but in which an application is not in operation.

In this case, the management control circuit 103 controls the optical connection switching fabric 101 to make connections of the respective ports l to r to the optical power monitoring port s in succession (in a circulating fashion) so that the optical power can be monitored by the light-receiving element cs′ placed in the optical input port of the optical power monitoring port s. The optical power monitor information is transmitted from the light reception circuit 102 to the management control circuit 103 and is retained in the storage medium 106.

On the other hand, the procedure of monitoring the ports h, i, j and k in which the application is in action is as follows. In this case, let it be assumed that the connection is made through the optical connection switching fabric 101 between the ports h-i and between the ports j-k.

In this case, difficulty is encountered in breaking the connection between the IT equipment r to make the connection thereof to the optical power monitoring port s for monitoring. For this reason, in this case, the input optical power from the equipment H connected to the port h is monitored by the light-receiving element ci′ provided in the optical output port of the port i connected thereto. Likewise, the input optical power from the IT equipment I, the input optical power from the IT equipment J and the input optical power from the IT equipment K are monitored by the light-receiving elements ch′, ck′ and cj′ of the ports h, k and j, respectively. Also in this case, each of the optical power monitor information is transmitted from the light reception circuit 102 to the management control circuit 103 and is retained in the storage medium 106.

Through the use of the above-mentioned procedures, the optical power monitor becomes feasible without cutting off the data on the application which is in operation on the network. Incidentally, in both the aforesaid cases of (d-1) and (d-2), a decision as to whether the IT equipment r is connected or not is made, for example, according to the following procedure. That is, also in this case, a given threshold set with respect to the optical power monitor value and, when the optical power monitor value varies to exceed the threshold, a decision is made as the new connection of the IT equipment r. On the other hand, when the optical power monitor value varies to be lower than the threshold, a decision is made that the IT equipment r is disconnected or that some trouble occurs.

(e) Switching Function to Redundant Path

Secondly, a description will be given hereinbelow of an example in which the function of the switching to a redundant path is realized through the use of the above-mentioned monitoring function.

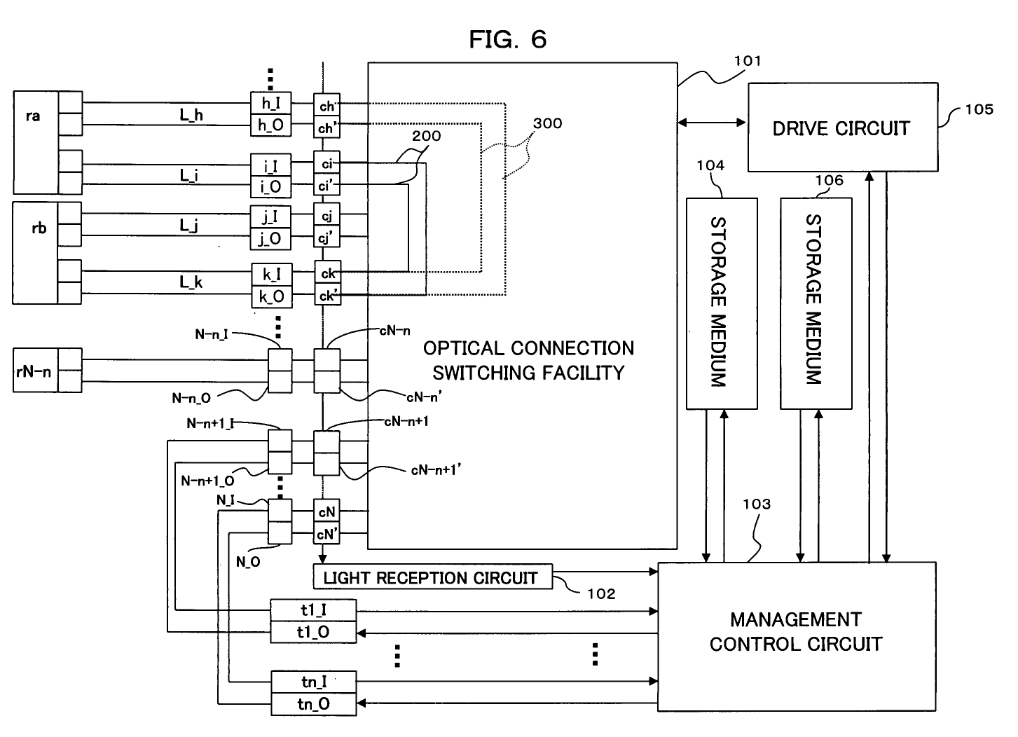

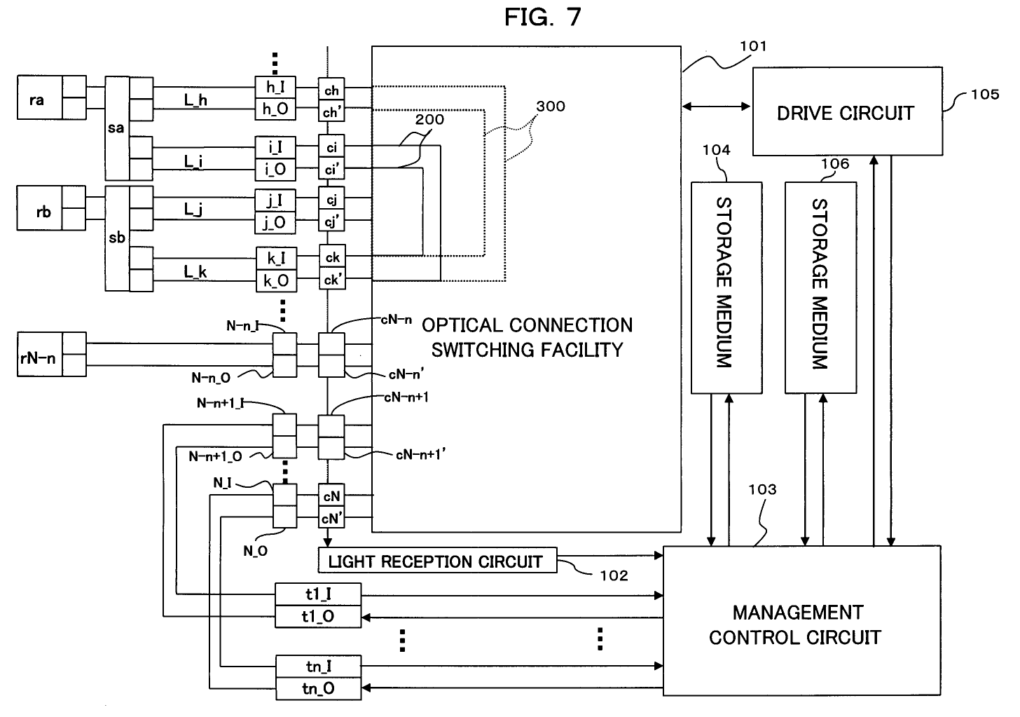

For example, let it be assumed that, as shown in FIG. 6, each of the IT equipment ra and rb has two pairs of optical transceiving unit ports (four ports in total) as the input and output and the IT equipment r are connected through the optical transceiving unit ports to two sets of optical input/output ports of the optical connection switching fabric 101 wherein one is used as a working port and the other is used as a spare (protection) port. However, in this case, it is not required that the IT equipment ra and rb themselves internally include the two pairs of ports, and for example, it is also considered that, as shown in FIG. 7, the IT equipment ra and rb internally include one pair of optical transceiving unit ports and units (signal branching units) sa and sb for splitting a signal are inserted thereinto separately so that the IT equipment ra and rb are apparently equipped substantially with two pairs of optical transceiving unit ports.

Moreover, in FIGS. 6 and 7, one pair of the two pairs of optical transceiving unit ports of the IT equipment ra are connected to optical input/output ports h_I and h_O and the other pair are connected to optical input/output ports i_I and I_O, while one pair of the two pairs of optical transceiving unit ports of the IT equipment rb are connected to optical input/output ports j_I and j_O and other pair are connected to optical input/output ports k_I and k_O.

In this case, although the optical input/output ports with the same number are allocated to one pair of optical transceiving unit ports of the IT equipment ra, rb, the optical input port number and the optical output port number are sometimes different from each other.

In addition, as the following setting items, the ports h_I, h_O and the ports i_I, i_O are set to have a redundant configuration, and the ports j_I, j_O and the ports k_I, k_O are set to have a redundant configuration. In FIGS. 6 and 7, each of L_h, L_i, L_j and L_k represents an optical link.

Still additionally, in the service providing state, let it be assumed that in the optical connection automatic-switching apparatus, the connection is made between the optical input port h_I and the optical output port k_O and between the optical input port k_I and the optical output port h_O, and the communication is established through the optical links L_h and L_k between the IT equipment ra and the IT equipment rb (see dotted-line paths 300 in FIGS. 6 and 7).

In this state, if a trouble occurs in the optical link L_h between the IT equipment ra and the optical input/output port h_IO, through the use of the light-receiving element ch or ch′ provided in this optical input/output port h_IO, the control circuit 103 detects the optical power disconnection through the light reception circuit 102. This detection procedure is conducted as mentioned above in the item (c). When detecting the optical power disconnection, the control circuit 103 controls the optical connection switching fabric 101 to connect the optical input/output port k_IO to a redundant path port (spare port) i_IO set in the optical input/output port h_IO in advance (see solid-line paths 200 in FIGS. 6 and 7). Thus, even if a trouble occurs in a path between the IT equipment ra and rb, the trouble is detectable through the optical power monitor to enable the automatic restoration from the trouble within a short time.

That is, in this case, in response to the detection of optical disconnection of the working port, the management control circuit 103 functions as a work/spare switching control unit 137 (see FIG. 1) to control the optical connection switching fabric 101 for switching the using port for the IT equipment r to the aforesaid spare port.

(f) Network Automatic-Constructing Function

On the basis of the logical address and/or physical address of the IT equipment r, the IT equipment rare previously set which are to be mutually connected in constructing a network in a datacenter. According to the procedures mentioned above in the items (a), (b) and (c), a correspondence table (port-address correspondence table) between the logical addresses and/or physical addresses of the newly connected equipment r and the ports is produced in the storage medium 104 and preserved therein. Therefore, by making reference to both the port-address correspondence table and the connection setting between the logical addresses and/or physical addresses made in advance, it is possible to automatically realize the new equipment connection to the network construction (inter-port connections).

(g) Method of Conforming New IT equipment Connection in Non-connected (Free) Port of Optical Switch

In a case in which the monitor is made using the method mentioned above in the item (d-2), since the optical connection switching fabric 101 is controlled so as to switch the inter-port connection one by one for the monitor, the extra time is taken. A description will be given hereinbelow of a method of recognizing the connection of the new equipment r without making the connection switching by the optical connection switching fabric (optical switch) 101.

(g-1) Input/Output (Transmission/Reception) Port Direct-Coupling Method

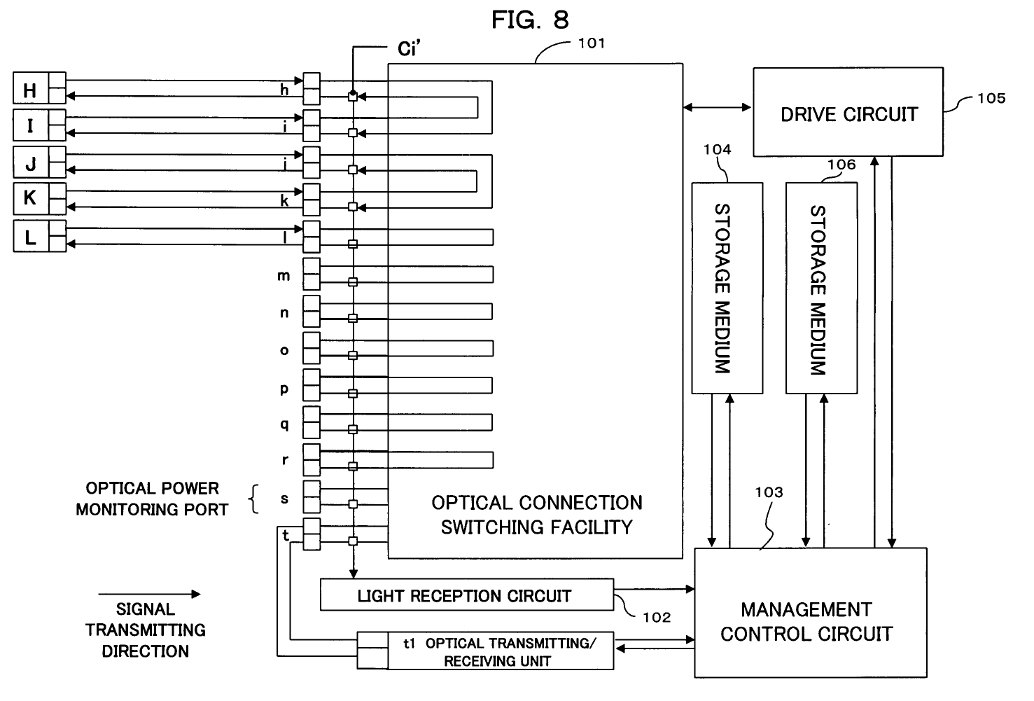

FIG. 8 shows an example of connection in the case of the employment of this method. In this example, the light-receiving element ci′ is provided in only the optical output port i_O of each of the optical input/output ports i_IO (h to t). In FIG. 8, unless otherwise specified particularly, the same reference marks as those used above designate the same or corresponding parts.

Moreover, as shown in FIG. 8, in the ports (free ports) l, m, n, o, p, q and r to which the IT equipment r (=H, I, J, K) is not connected, the optical input port and the optical output port are set in a state directly coupled by the optical switch 101.

In this state, for example, as shown in FIG. 8, in a case in which the IT equipment L is newly connected to the port l, light from this IT equipment L is inputted through the optical input port of the port l and is directly inputted to the light-receiving element of the optical output port of the port l by means of the turn-around connection in the optical connection switching fabric 101. This enables the management control circuit 103 the optical power variation information through the light reception circuit 102, and the management control circuit 103 can recognize the new connection of the IT equipment L to the port l without performing the inter-port connection switching by the optical switch 101.

That is, in this case, in a state where the aforesaid equipment state monitoring unit 131 (see FIG. 1) controls the optical connection switching fabric 101 to directly couple the optical input port i_I and the optical output port i_O, paired, as the optical input/output port i_IO to which the IT equipment is not connected, the control circuit 103 functions as a port turn-around connection equipment state monitoring unit 138 (see FIG. 1) which, with the light reception quantity in the light-receiving element ci′ of the optical output port i_O being handled as the light power information, monitors a variation thereof for monitoring the connection, disconnection or communication state of the IT equipment r.

Following this, as well as the above-described example, the management control circuit 103 controls the optical connection switching fabric 101 to establish the connection between the optical transceiving unit tk and the newly connected equipment L so that the communication is made with this IT equipment L to acquire the necessary information such as the address information for produce a port-address correspondence table, thereby controlling the optical switch 101 on the basis of this correspondence table to establish the connection between the IT equipment L and another IT equipment r which is the other communication party.

(g-2) Quasi-Fixing Method

In a case in which the IT equipment r is connected to the optical switch 101 according to the method mentioned above in the item (g-1), the light outputted from the IT equipment L is returned through the optical switch 101 to the receiving port of the IT equipment r. For example, if the connected IT equipment r is a layer-2 switch, due to this connection, disorder occurs in the MAC (Media Access Control) address table retained in the equipment r so that the communication abnormality occurs.

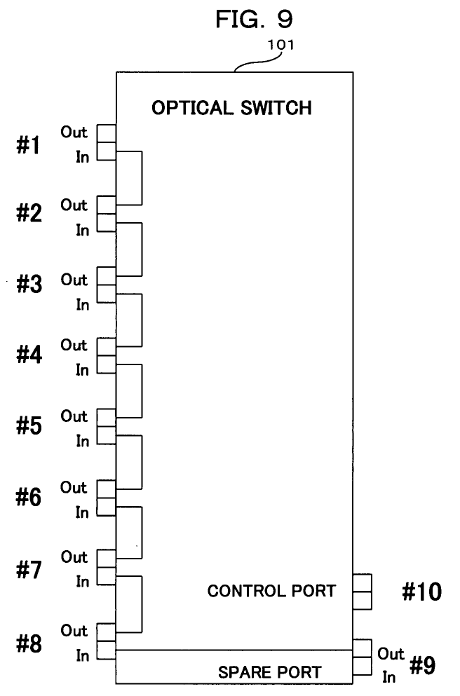

Accordingly, another method is taken. That is, in the optical switch 101, with respect to the free ports, instead of the direct coupling between the optical input and output of the same free port, for example, as shown in FIG. 9, the optical input port (In) and the optical output port (Out) of the free ports adjacent to each other (in this case, the eight ports with numbers 1 to 8 in total) are set in a state directly coupled (turn-around-connected) to each other to, when the IT equipment r is newly connected to the free port of the optical switch 101, prevent the output light of this IT equipment from returning directly to the IT equipment.

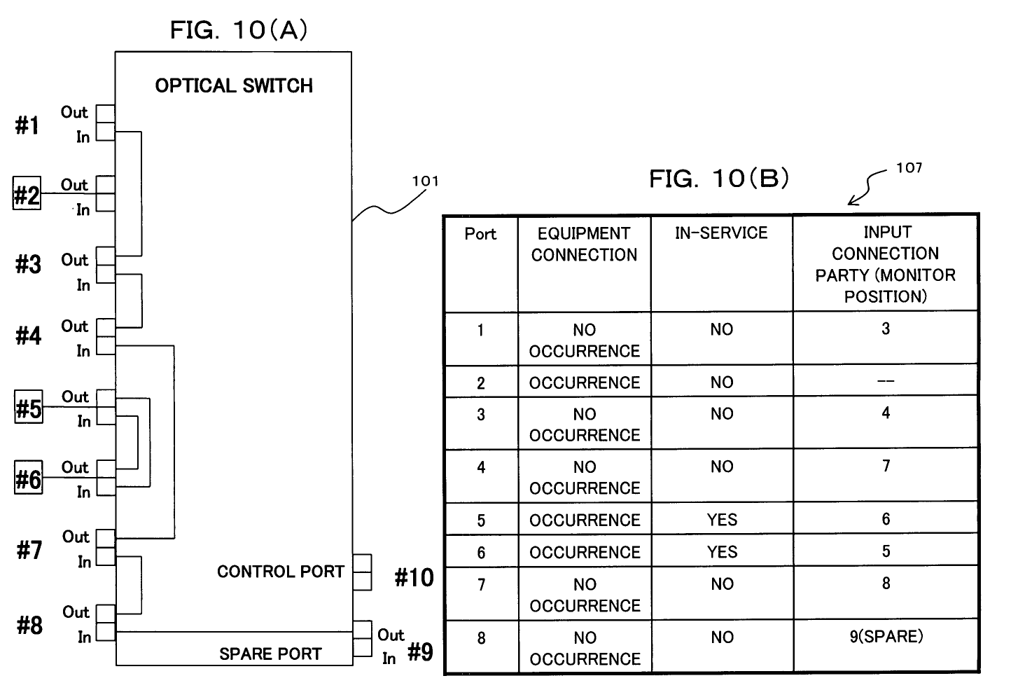

In addition, for example, when, as shown in FIG. 10(A), the equipment r is connected to the free port of port number=2 (however, in a service non-providing condition) and the equipment r, which mutually make communication with each other, are connected to the free port of the port number=5 and the free port of port number=6 and the service is in a providing condition, the optical switch 101 takes a connection set condition in which the optical input port of the port number=5 and the optical output port of the port number=6 are connected to each other, the optical output port of the port number=5 and the optical input port of the port number=6 are connected to each other, and the other free ports are directly coupled to each other. The optical switch 101 shown in FIG. 10(A) is additionally equipped with a spare port (port number=9) and a control port (port number=10).

In this case, for example, as shown in FIG. 10(B), the control circuit 103 retains and manages, in the storage medium 104 or 106, the information for each port (number) of the optical switch 101, such as the occurrence or non-occurrence of equipment connection, whether this equipment r is in operation (in service) and the optical input port connection party (monitor position) (=port number), as data in the form of a table (equipment information management table 107). In this example, the ports (in FIG. 10(A), port numbers=2, 5 and 6) connected to the IT equipment are not put to use for the optical power monitor. Moreover, the management control circuit 103 does not monitor these ports connected to the IT equipment r at all times and, at the occurrence of an instruction on the inter-equipment connection or the like, controls the optical switch 101 as needed to make the connection with the control port (optical power monitoring port) (in FIG. 10(A), port number=10) for monitoring them.

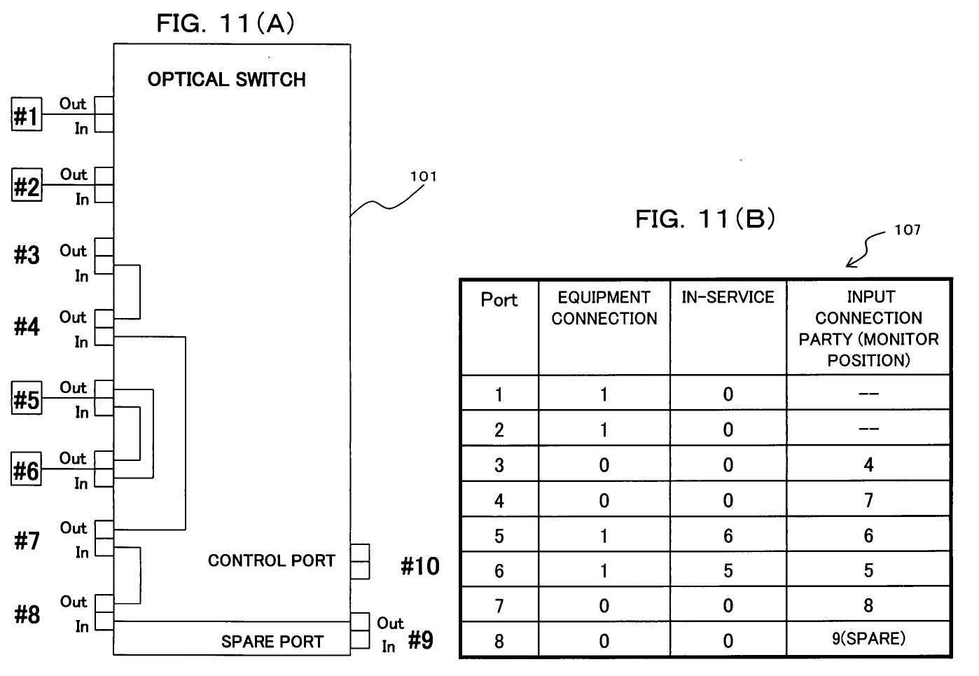

FIG. 11(A) shows a connection state in the optical switch 101 when the It equipment (in a service non-providing condition) is further connected to the optical input/output port of the port number=1 in the state shown in FIG. 10(A), and FIG. 11(B) shows a concrete example of the aforesaid equipment information management table 107 in this state. As shown in FIG. 11(B), in this example, the occurrence and non-occurrence of the equipment connection are designated at “1” (occurrence) and “0” (non-occurrence), and each of the other connection party to the equipment and the other connection party to the optical input port is expressed by a port number.

For example, in FIG. 11(B), the entry (“1”, “0”, “--”) for the port number=1, 2 signifies that, although the equipment r are connected to the ports corresponding to the port number=1, 2 (“1”), since the service is in a non-providing condition, the other connection party does not exist (“0”) and there is no need for the monitor. Moreover, the entry (“0”, “0”, “4”/“7”) for the port number=3, 4 signifies that the ports corresponding to the port number=3, 4 are free and the optical input ports thereof are connected (directly coupled) to the free ports (optical output ports) corresponding to the port number=4, 7.

Moreover, the entry (“1”, “6”, “6”) for the port number=5 signifies that the equipment r is connected to the port of the port number=5 and the other connection party (communication party) therefor is the equipment r connected to the port of the port number=6 and the communication is monitored by the optical output port of the port number=6. Likewise, the entry (“1”, “5”, “5”) for the port number=6 signifies that the equipment r is connected to the port of the port number=6 and the other connection party (communication party) therefor is the aforesaid equipment r connected to the port of the port number=5 and the communication is monitored by the optical output port of the port number=5.

Still moreover, the entry (“0”, “0”, “8”) for the port number=7 signifies that the port of the port number=7 is free and the optical input port thereof is connected (directly coupled) to the optical output port of the port number=8 so that the optical power monitor is made through the use of this optical output port, and the entry (“0”, “0”, “9”) for the port number=8 signifies that the port of the port number=8 is free and the optical input port thereof is connected (directly coupled) to the optical output port (spare port) of the port number=9 so that the optical power monitor is made through the use of this spare port.

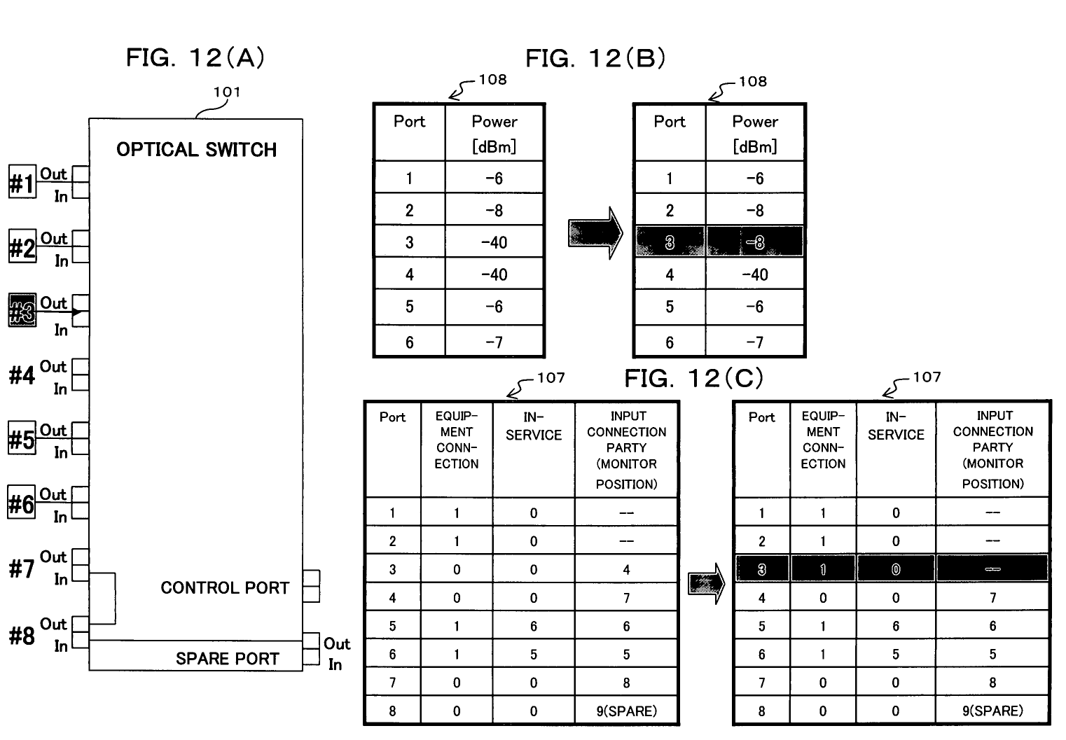

In this state, for example, as shown in FIG. 12(A), when the equipment r is newly connected to the free port (port number=3) of the optical switch 101, the output light from this equipment r is incident on the light-receiving element c4′ provided in the optical output port of the port number=4 and is transmitted through the light reception circuit 102 to the control circuit 103. Therefore, for example, as shown in FIG. 12(B), the control circuit 103 updates that entry contents of the optical power information (optical power information management table 108) for each port retained and managed in the storage medium 106. FIG. 12(B) shows a state in which the optical power before the connection of the equipment r is “−40 dBm” and it is updated to “−8 dBm” through the connection of the equipment r.

In addition, the management control circuit 103 controls the optical switch 101 to cancel the connection (direct coupling) between the optical input port of the port number=3 and the optical output port of the port number=4 and, for example, as shown in FIG. 12(C), updates the entry contents of the equipment information management table 107. That is, with respect to the entry of the port number=3, the “equipment connection” is set at “1” (occurrence) and the re-allocation is made in terms of the monitor position. In FIG. 12(C), although the monitor position (port) is in a non-allocated condition since the newly connected equipment r is in a service non-providing condition, the allocation of the monitor position is determined afterwards when the equipment r is determined as the other communication party and the mutual connection is established therebetween. Following this, the control circuit 103 carries out the optical power monitor at this monitor position.

That is, in this case, the management control circuit 103 functions as an adjacent port connection equipment state monitoring unit 139 which, in a state where the aforesaid equipment state monitoring unit 131 (see FIG. 1) controls the optical connection switching fabric 101 to directly couple the optical input port i_I and the optical output port i_O of the adjacent optical input/output port (free port) i_IO to which the equipment r is not connected and the light reception quantity in the light-receiving element ci′ of the optical output port i_IO is handled or employed as the optical information, monitors a variation thereof.

(h) IT Equipment Connection Automatic-Recognition Based on Cooperation between Connected Equipment Information and Optical Power Information

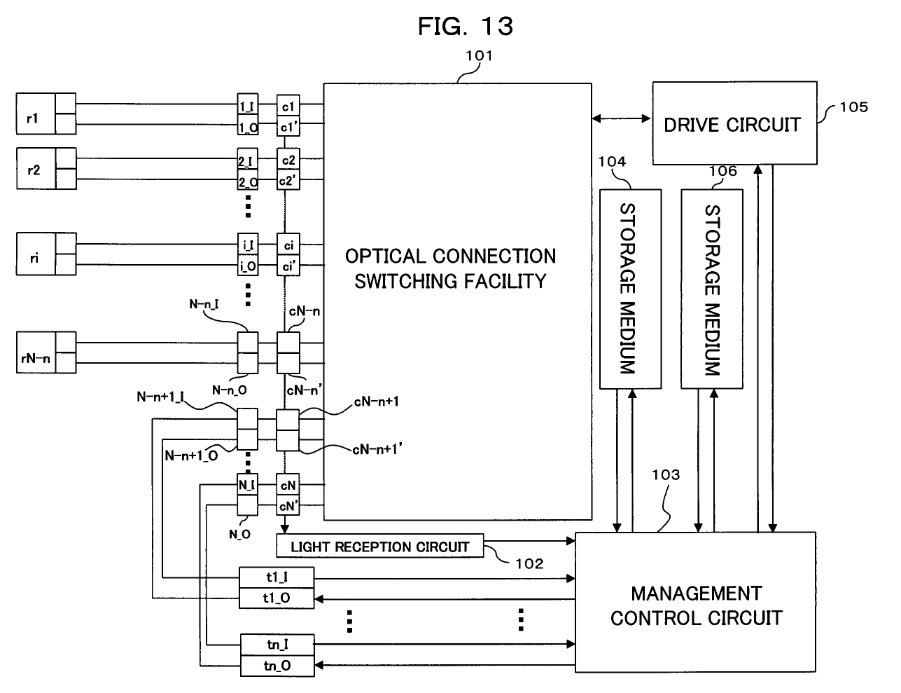

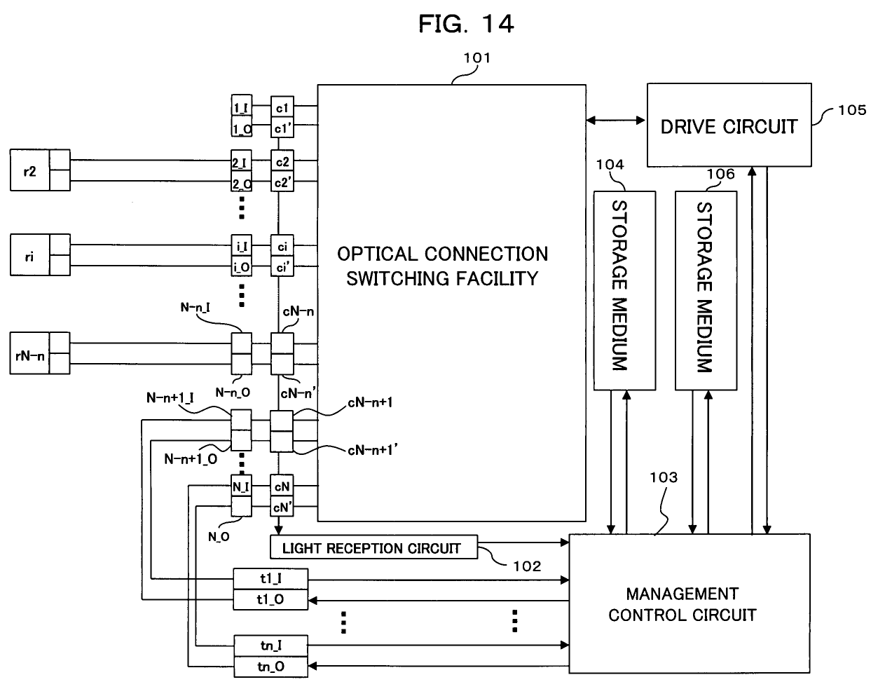

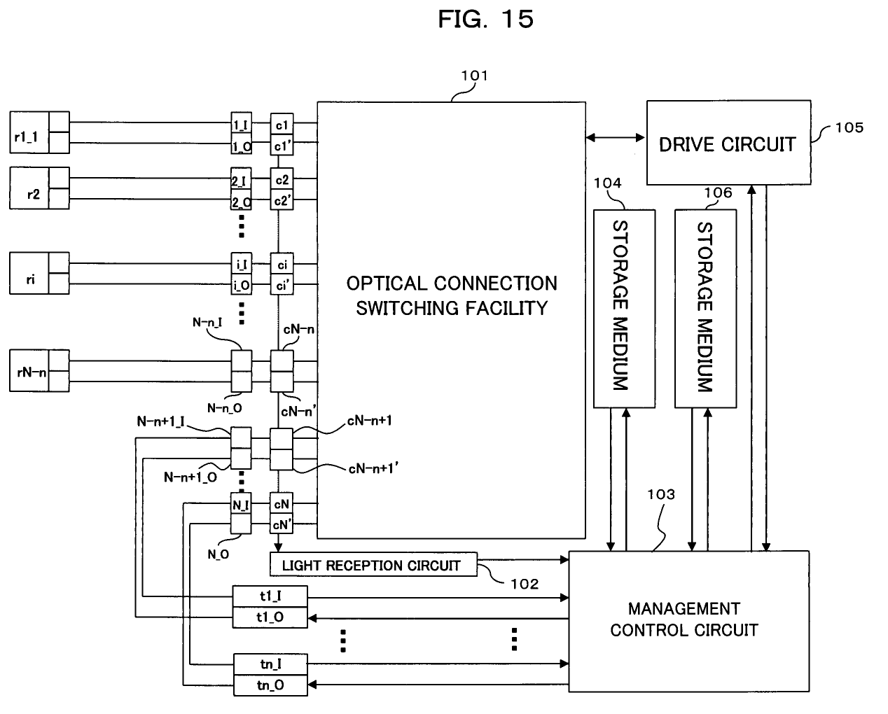

As FIG. 13 shows, let it be assumed that the IT equipment r1, r2, ri, . . . , rN-n are connected to this optical connection automatic-switching apparatus (state h1) and, in this state, the IT equipment r1, which has been connected to the port 1_IO, is disconnected from this optical connection automatic-switching apparatus as shown in FIG. 15 (state h2) and, thereafter, the IT equipment r1_2 is newly connected to the same port 1_IO as shown in FIG. 15 (state h3).

In this case, according to only the information in the optical power information retaining storage medium 106, even if the equipment connection state varies such that the state h1→the state h2→the state h3, the management control circuit 103 observes only the optical power variation of rise (up)→fall (down)→rise (up) for the port 1_IO, and difficulty is encountered in distinguishing between the state h1 and the state h3.

In this case, the additional use of the information in the equipment information retaining storage medium 104 enables finer state management.

First, in the case of the state h1 (see FIG. 13), for example, the equipment information in the storage medium 104 and the optical power information in the storage medium 106 are as shown in the following tables 2 and 3.

TABLE 2
Information in Storage Medium 104

| Port No. | Equipment |
|---|---|
| 1 | r1 |
| 2 | r2 |
| . | . |
| . | . |
| . | . |
| H | rh |
| I | ri |
| . | . |
| . | . |
| . | . |
| N − n | — |

TABLE 3
Information in Storage Medium 106

| Port No. | Optical Power [dBm] |
|---|---|
| 1 | −6 |
| 2 | −8 |
| . | . |
| . | . |
| . | . |
| H | −9 |
| I | −7 |
| . | . |
| . | . |
| . | . |
| N − n | −40 |

In the case of shifting to the aforesaid state h2, for example, the equipment information in the storage medium 104 and the optical power information in the storage medium 106 become as shown in the following tables 4 and 5, and due to the cutoff of the optical power and the disappearance of the connected equipment information, the control circuit 103 can recognize that the IT equipment r1, which has been connected to the port 1_IO of the port number=1, is disconnected therefrom.

TABLE 4
Information in Storage Medium 104

| Port No. | Equipment |
|---|---|
| 1 | |
| 2 | r2 |
| . | . |
| . | . |
| . | . |
| H | rh |
| I | ri |
| . | . |
| . | . |
| . | . |
| N − n | — |

TABLE 5
Information in Storage Medium 106

| Port No. | Optical Power [dBm] |
|---|---|
| 1 | −40 |
| 2 | −8 |
| . | . |
| . | . |
| . | . |
| H | −9 |
| I | −7 |
| . | . |
| . | . |
| . | . |
| N − n | −40 |

Moreover, when the IT equipment r1_1 is connected to the port 1_IO and the shifting to the aforesaid state h3 occurs, the equipment information in the storage medium 104 and the optical power information in the storage medium 106 become as shown in the following tables 6 and 7.

TABLE 6
Information in Storage Medium 104

| Port No. | Equipment |
|---|---|
| 1 | r1_1 |
| 2 | r2 |
| . | . |
| . | . |
| . | . |
| H | rh |
| I | ri |
| . | . |
| . | . |
| . | . |
| N − n | — |

TABLE 7
Information in Storage Medium 106

| Port No. | Optical Power [dBm] |
|---|---|
| 1 | −6 |
| 2 | −8 |
| . | |
| . | |
| . | |
| H | −9 |
| I | −7 |
| . | |
| . | |
| . | |
| N − n | −40 |

In this case, although difficulty is experienced in distinguishing from the state 1 on the basis of only the optical power information, by making reference to the connected equipment information in the storage medium 104, the control circuit 103 can recognize that the IT equipment r1_1 different from that in the state 1 is newly connected thereto.

(i) Trouble Detection at Disconnection of Output Side Fiber

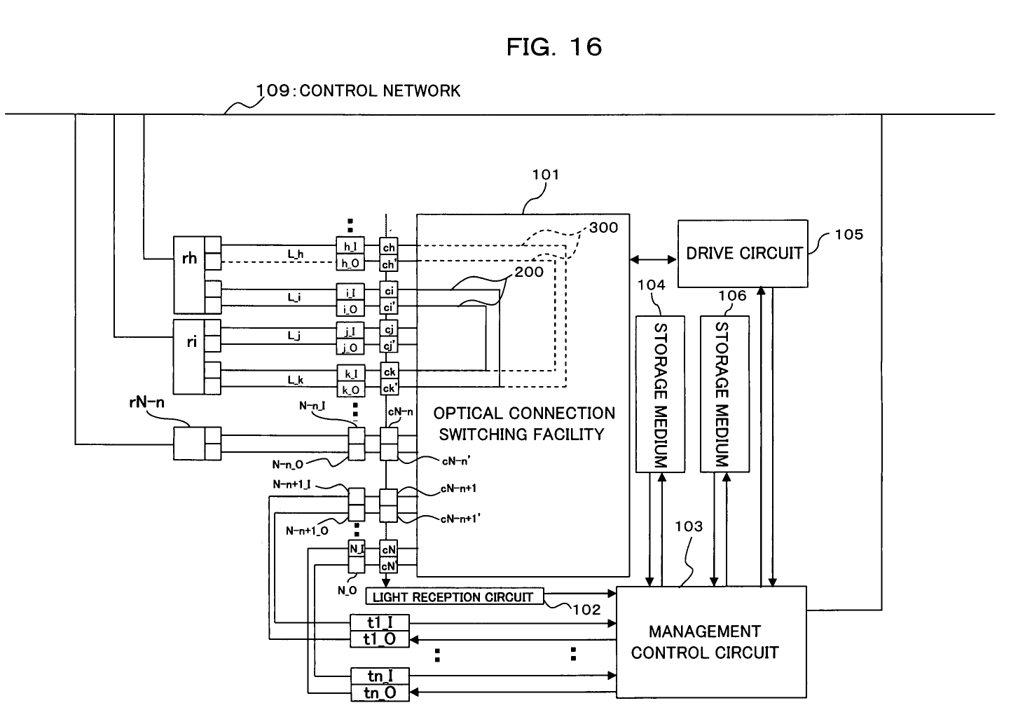

In the redundant configuration (see FIGS. 6 and 7) described above in the item (e), if a trouble (disorder) occurs in the optical link L_h connected to the optical output port h_O of this optical connection automatic-switching apparatus, the light-receiving element ch or ch′ provided in this connection automatic-switching apparatus cannot detect that trouble. For this reason, the trouble is detected through the use of a separate line network 109 shown in FIG. 16. This network will be referred to hereinafter as a control network 109. This control network 109 is a network connected so that the management control circuit 103 and each IT equipment r are communicable with each other.

Accordingly, an interface is provided in each of the IT equipment r and the management control circuit 103 of this optical connection automatic-switching apparatus for the connection to this control network 109. Moreover, in a case in which a trouble occurs in the optical link L_h connected to the optical output port h_O of this optical connection automatic-switching apparatus, the communication is cut off between the equipment rh and the equipment ri. The equipment rh or ri detects this information on the communication cutoff and notifies the trouble information through the control network 109 to the management control circuit 103 of the optical connection automatic-switching apparatus. Therefore, the optical connection automatic-switching apparatus (management control circuit 103) can recognize the trouble and can perform the switching to the redundant path as mentioned above.

As described above in detail, according to this embodiment, the optical network connection switching can be automated at the equipment connection management, the optical network re-construction and the occurrence of a trouble and, hence, the time needed for that operation is considerably reducible up to approximately 1 hour, as compared with the conventional technique depending on the manual operation and requiring several days to several weeks for the operation. Therefore, the maintenance/operation/management cost of an optical network constructed through the use of this optical connection automatic-switching apparatus is considerably reducible.

In addition, since one optical connection automatic-switching apparatus (body of equipment) can cope with diverse types of optical communication interfaces, the number of connection switching apparatus to be used for the connections is considerably reducible, thus lowering the initial introduction cost at the optical network construction.

Still additionally, when the management control circuit 103 or this circuit 103 and the storage media 104 and 106 is mounted as one function of a remote maintenance terminal or the like, the aforesaid connection management or the connection switching is remotely controllable from the terminal, which enables the operations such as the connection management and the connection switching in the optical connection switching fabric 101 to be conducted more efficiently.

It should be understood that the present invention is not limited to the above-described embodiment, and that it is intended to cover all changes and modifications of the embodiment of the invention herein which do not constitute departures from the spirit and scope of the invention.

1. An optical connection switching apparatus to which a plurality of equipment each having an optical communication interface are connected and which is made to establish an optical connection between said equipment, said apparatus comprising:
an optical connection switching fabric having a plurality of an optical input/output ports each of which includes a pair of optical input port and an optical output port and making a connection between any one of said optical input ports and any one of said optical output ports;
one or more optical transceiving units connected to a part of said optical input/output ports; and
a management control unit for controlling said optical connection switching fabric to make a connection between said optical input/output port connected to said optical transceiving unit and said optical input/output port connected to said equipment for acquiring and managing information on said equipment by making a communication with said equipment through the use of said optical transceiving unit.

2. The optical connection switching apparatus according to claim 1, wherein said management control unit includes an equipment information storing unit for storing one of a physical address and a logical address of said equipment or both said addresses as said information (which will be referred to hereinafter as “equipment information”) on said equipment acquired by the communication with said equipment in a state associated with information on said optical input/output port.

3. The optical connection switching apparatus according to claim 1, wherein said management control unit includes an equipment state monitoring unit for monitoring a connection, disconnection or communication state of said equipment by monitoring optical power information on said optical input/output port.

4. The optical connection switching apparatus according to claim 3, wherein a light-receiving element is provided in said optical input port of said optical connection switching fabric, and
said equipment state monitoring unit is constructed as an input port equipment state monitoring unit which, when a quantity of light reception by said light-receiving element is employed as said optical power information, monitors the connection, disconnection or communication state of said equipment by monitoring a variation of said optical power information.

5. The optical connection switching apparatus according to claim 3, wherein a light-receiving element is provided in said optical output port of said optical connection switching fabric, and
said equipment state monitoring unit is constructed as an output port equipment state monitoring unit for controlling said optical connection switching fabric to make a connection between said optical input port which is connected to said equipment and said optical output port which is not connected to said equipment so that, when a quantity of light reception by said light-receiving element of said optical output port is employed as said optical power information, the connection, disconnection or communication state of said equipment is monitored by monitoring a variation of said optical power information.

6. The optical connection switching apparatus according to claim 3, wherein a light-receiving element is provided in said optical output port of said optical connection switching fabric, and
said equipment state monitoring unit is constructed as a port turn-around connection equipment state monitoring unit for controlling said optical connection switching fabric to make direct coupling between said optical input port and said optical output port of said optical input/output port which is not connected to said equipment so that, when a quantity of light reception by said light-receiving element of said optical output port is employed as said optical power information, the connection, disconnection or communication state of said equipment is monitored by monitoring a variation of said optical power information.

7. The optical connection switching apparatus according to claim 3, wherein a light-receiving element is provided in said optical output port of said optical connection switching fabric, and
said equipment state monitoring unit is constructed as an adjacent port connection equipment state monitoring unit for controlling said optical connection switching fabric to make direct coupling between said optical input port and said optical output port of said optical input/output ports which are adjacent to each other and which are not connected to said equipment so that, when a quantity of light reception by said light-receiving element of said optical output port is employed as said optical power information, the connection, disconnection or communication state of said equipment is monitored by monitoring a variation of said optical power information.

8. The optical connection switching apparatus according to claim 3, wherein, when one of said equipment is connected to two of said input/output ports so that one is used as a working port and the other is used as a spare port, said management control unit includes a work/spare switching control unit for, when said equipment state monitoring unit detects an optical disconnection on said working port, controlling said optical connection switching fabric to switch a port to be used for said equipment to said spare port.

9. The optical connection switching apparatus according to claim 1, wherein said management control unit includes:
equipment information storage unit for storing one of a physical address and a logical address of said equipment or both said addresses as said information (which will be referred to hereinafter as “equipment information”) on said equipment acquired by the communication with said equipment in a state associated with information on said optical input/output port;
an optical power information storage unit for storing optical power information on said optical input/output port; and
an equipment state monitoring unit for monitoring connection, disconnection or communication state of said equipment on the basis of said equipment information in said equipment information storage unit and said optical power information in said optical power information storage unit.

10. The optical connection switching apparatus according to claim 9, wherein said management control unit includes an inter-port connection control unit for carrying out inter-port connection control in said optical connection switching fabric on the basis of said equipment information in said equipment information storage unit.

11. The optical connection switching apparatus according to claim 9, wherein a light-receiving element is provided in said optical input port of said optical connection switching fabric, and
said equipment state monitoring unit is constructed as an input port equipment state monitoring unit which, when a quantity of light reception by said light-receiving element is employed as said optical power information, monitors the connection, disconnection or communication state of said equipment by monitoring a variation of said optical power information.

12. The optical connection switching apparatus according to claim 9, wherein a light-receiving element is provided in said optical output port of said optical connection switching fabric, and
said equipment state monitoring unit is constructed as an output port equipment state monitoring unit for controlling said optical connection switching fabric to make a connection between said optical input port which is connected to said equipment and said optical output port which is not connected to said equipment so that, when a quantity of light reception by said light-receiving element of said optical output port is employed as said optical power information, the connection, disconnection or communication state of said equipment is monitored by monitoring a variation of said optical power information.

13. The optical connection switching apparatus according to claim 12, wherein said output port equipment state monitoring unit includes a port circulation connection control unit for controlling said optical connection switching fabric to make connections of said plurality of optical input ports connected to said equipment with said optical output port, non-connected to said equipment and serving as an optical power monitoring port, in a circulating fashion.

14. The optical connection switching apparatus according to claim 13, wherein a plurality of optical power monitoring ports each corresponding to said optical power monitoring port are provided to monitor the optical power information on said optical input/output ports in said optical connection switching fabric in a sharing fashion.

15. The optical connection switching apparatus according to claim 9, wherein a light-receiving element is provided in said optical output port of said optical connection switching fabric, and
said equipment state monitoring unit is constructed as a port turn-around connection equipment state monitoring unit for controlling said optical connection switching fabric to make direct coupling between said optical input port and said optical output port of said optical input/output port which is not connected to said equipment so that, when a quantity of light reception by said light-receiving element of said optical output port is employed as said optical power information, the connection, disconnection or communication state of said equipment is monitored by monitoring a variation of said optical power information.

16. The optical connection switching apparatus according to claim 9, wherein a light-receiving element is provided in said optical output port of said optical connection switching fabric, and
said equipment state monitoring unit is constructed as an adjacent port connection equipment state monitoring unit for controlling said optical connection switching fabric to make direct coupling between said optical input port and said optical output port of said optical input/output ports which are adjacent to each other and which are not connected to said equipment so that, when a quantity of light reception by said light-receiving element of said optical output port is employed as said optical power information, the connection, disconnection or communication state of said equipment is monitored by monitoring a variation of said optical power information.

17. The optical connection switching apparatus according to claim 9, wherein, when one of said equipment is connected to two of said input/output ports so that one is used as a working port and the other is used as a spare port, said management control unit includes a work/spare switching control unit for, when said equipment state monitoring unit detects an optical disconnection on said working port, controlling said optical connection switching fabric to switch a port to be used for said equipment to said spare port.

18. The optical connection switching apparatus according to claim 2, wherein said management control unit includes an inter-port connection control unit for carrying out inter-port connection control in said optical connection switching fabric on the basis of the equipment information stored in said equipment information storage unit provided in said management control unit.

19. The optical connection switching apparatus according to claim 1, wherein the plurality of optical transceiving units are connected to said optical input/output ports so as to correspond to a plurality of types of optical communication interfaces to be provided in said equipment, and
said management control unit includes an interface scanning unit which controls said optical connection switching fabric to make connections between said optical input/output ports connected to said plurality of optical transceiving units and the optical input/output port connected to said equipment in a circulating fashion for acquiring the information on said equipment through the use of said optical transceiving units.

20. The optical connection switching apparatus according to claim 1, wherein said optical transceiving unit is constructed as a multi-interface supporting optical transceiving unit having a plurality of types of communication functions corresponding to a plurality of types of optical communication interfaces to be provided in said equipment, and
said management control unit includes an interface scanning unit which selects and sets said communication functions of said optical transceiving unit in a circulating fashion to acquire the information on said equipment through the use of said optical transceiving unit.

21. A management control unit for an optical connection switching apparatus which includes an optical connection switching fabric having a plurality of an optical input/output ports each of which is composed of a pair of optical input port and an optical output port and making a connection between any one of said optical input ports and any one of said optical output ports, with each of a plurality of equipment each having an optical communication interface being connected to any one of said optical input/output ports to establish an optical connection between said equipment,
said management control unit comprising:
one or more optical transceiving units connected to a part of said optical input/output ports; and
a management control unit for controlling said optical connection switching fabric to make a connection between said optical input/output port connected to said optical transceiving unit and said optical input/output port connected to said equipment for acquiring and managing information on said equipment by making a communication with said equipment through the use of said optical transceiving unit.
